(19) United States
(12) Patent Application Publication
(10) Pub. No.: US 2010/0046769 A1
(43) Pub. Date: Feb. 25, 2010

(54) NOISE-CANCELING SYSTEM

(75) Inventor: Tominori KIMURA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: KABUSHIKI KAISHA AUDIO-TECHNICA, Tokyo (JP)

(21) Appl. No.: 12/510,679

(22) Filed: Jul. 28, 2009

(30) Foreign Application Priority Data
Aug. 21, 2008 (JP) 2008-213174

(51) Int. Cl. G10K 11/16

(52) U.S. Cl. 381/71.1

(57) ABSTRACT

The noise canceling system includes: a microphone unit picking up ambient noise and outputting a noise signal; a cancel signal generator generating and outputting a cancel signal eliminating the noise, and having a filter circuit outputting a signal in a predetermined frequency band included in the noise signal, an inverting amplifier circuit inverting and amplifying the output signal of the filter circuit, an amplification degree being greater than zero and smaller than one, and an adding circuit outputting a signal obtained by adding the output signal of the inverting amplifier circuit to the noise signal; and a speaker unit outputting an audio signal and the cancel signal.

### BACKGROUND OF THE INVENTION

1. Field of the Invention

The present invention relates to a noise-canceling system capable of canceling ambient noise, more specifically, the present invention relates to a noise-canceling system capable of correcting shift of phase occurred due to characteristics and outputting a more precise cancel signal.

2. Related Background of the Invention

When a noise-canceling system capable of canceling ambient noise using a cancel sound is applied to a headphone, the headphone can be used as a noise-canceling headphone which cancels ambient noise and with which one can listen to reproduced music. The noise-canceling headphone is constructed so that ambient noise picked-up by a microphone unit attached to a headphone case etc. is converted into an electric noise signal, a signal (cancel signal) canceling noise which is audible through the headphone case is generated using the noise signal, and a user can listen to music in a state where the ambient noise is canceled by the cancel sound output from a headphone speaker unit together with the reproduced music.

It is ideal if audible noise can be canceled perfectly by the cancel sound. However, the microphone unit and the speaker unit constituting the noise-canceling system have characteristics (phase characteristics) in that each phase shifts depending on a frequency. The phase characteristics have characteristics in that as a frequency becomes lower, each phase advances relatively, resulting in attenuation of gain, and as frequency becomes higher, each phase delays relatively. Since the cancel signal output from the speaker unit of the noise-canceling system is influenced by the phase characteristics, it is difficult to generate a cancel signal that cancels audible noise perfectly. In addition, if a cancel sound that has phase shift relative to noise by being affected with such phase shift characteristics is output from the speaker unit, in some times, not only a phenomenon that an effect of canceling noise (canceling effect) to be exhibited originally is reduced, but also a phenomenon that a specific frequency included in the noise is enhanced by the cancel signal may occur, thereby making the audible noise loud.

Moreover, other causes of a phenomenon that the phase of a cancel sound is shifted are also present. Since, various sounds are included in the ambient noise desired to be canceled, it is difficult to generate cancel sounds for all frequencies included in the noise. Thus, in the noise-canceling system, a frequency band for which cancel signals are generated is made to be narrow to some extent by using a filter circuit.

As filter circuits used for an audio signal, there are a low-pass filter that blocks signals each having a predetermined frequency or lower, a high-pass filter that blocks signals each having a predetermined frequency or higher, a band-pass filter that blocks signals having frequency other than a predetermined frequency band, and a notch filter that blocks a signal having a predetermined frequency band. The noise-canceling headphone is configured so that a frequency band exhibiting a canceling effect is determined to generate a predetermined cancel signal by using these filter circuits in combination with each other. In other words, in the noise canceling headphone, the filter circuits pick up a signal for use of generating a cancel signal from a noise signal to limit a frequency band. According to such a configuration, although a canceling effect is exhibited with respect to a specific frequency band, it is not possible to exhibit the canceling effect with respect to other frequency bands. Thus, for the purpose of canceling more various noises, a noise canceling system, mounting a plurality of filter circuits thereon, and capable of increasing kinds of cancelable noises by selectively switching filter circuits using a switch etc., has been known (for example, refer to “patent document 1”).

[Patent document 1] JP 04-008099 A

While there are various types of filter circuits, such as a passive type circuit using a passive element, and an active type circuit using an operational amplifier etc., anyone of the filter circuits has characteristics in that, as the frequency of a frequency component of an input original signal is lower, the phase of the component advances relatively, and as the frequency of the component is higher, the phase delays relatively.

In this manner, in the noise-canceling system, according to phase characteristics of its configuration and phase characteristics of filter circuits, relative phase shift between the audible noise and the cancel sound tends to occur. Accordingly, in order to enhance the noise-canceling effect by outputting a more precise cancel signal, a noise-canceling system capable of generating and outputting a cancel signal where the above-described phase characteristics is corrected, is necessary. In order to correct the phase characteristics, a circuit having such characteristics that phases of low frequencies included in the noise signal delay relatively, and phases of high frequencies advance relatively, should be realized. It is necessary for realizing such phase characteristics in a filter circuit to use an element where its impedance decreases at high frequency region thereby advancing the phase or to use an element where its impedance increases at low frequency region thereby delaying the phase, as a constituent element of the filter circuit. However, because there is not such a constituent element in an electronic circuit, it is impossible to realize such a filter circuit.

### SUMMARY OF THE INVENTION

In order to reduce influence of phase characteristics on a cancel signal as much as possible, a conventional noise-canceling system has been devised such that its phase does not shift by suitably combining various kinds of filters so as to match the phase. With this arrangement, disadvantages due to influence of phase characteristics tend to be reduced. However, since phase characteristics of anyone of the filter circuits have characteristics in that as frequency is lower, its phase advances relatively, and as frequency is higher, its phase delays relatively, it has been difficult for a frequency to be a joint of a plurality of filter circuits to correct its phase characteristics, and since at the joint frequency, the canceling effect is extremely degraded. In order to prevent the phenomenon, it has been necessary to balance by suppressing total canceling amounts. For this reason, the conventional noise-canceling system had an insufficient canceling effect to output an auditorily unnatural sound.

The present invention has been made in view of the above-mentioned problem, and has an object to provide a noise-canceling system that includes a filter circuit having phase characteristics capable of correcting conventional phase characteristics in the noise-canceling system capable of canceling ambient noise and can output a phase-shift corrected cancel signal.

According to an aspect of the present invention, a noise-canceling system comprises: a microphone unit picking up ambient noise and outputting a noise signal; a cancel signal generator generating and outputting a cancel signal that eliminates the noise; and a speaker unit outputting an audio signal and the cancel signal, wherein the cancel signal generator includes: a filter circuit outputting a signal included in the noise signal in a predetermined frequency band; an inverting amplifier circuit inverting and amplifying the output signal of the filter circuit, an amplification degree being greater than zero and smaller than one; and an adding circuit outputting a cancel signal obtained by adding the output signal of the inverting amplifier circuit to the noise signal.

Moreover, according to another aspects of the present invention, a noise-canceling system comprises: a microphone unit picking up ambient noise and outputting a noise signal; a cancel signal generator generating and outputting a cancel signal that eliminates the noise; and a speaker unit outputting an audio signal and the cancel signal, wherein the cancel signal generator includes: a filter circuit outputting a signal included in the noise signal in a predetermined frequency band; an amplifier circuit amplifying the output signal of the filter circuit, an amplification degree being greater than zero and smaller than one; and a subtracting circuit outputting a cancel signal obtained by subtracting the output signal of the amplifier circuit from the noise signal.

Moreover, in the noise-canceling system, the filter circuit may be a low-pass filter, a high-pass filter, a band-pass filter, or a notch filter.

Moreover, according to further aspects of the present invention, a noise-canceling method using a noise-canceling system comprising: a microphone unit picking up and outputting ambient noise; a cancel signal generator generating and outputting a cancel signal canceling the noise, which has a filter circuit that outputs a signal in a predetermined frequency band included in the noise signal, an inverting amplifier circuit that inverts the output signal of the filter circuit and amplifies the signal at amplification degree being greater than zero and smaller than one, and an adding circuit that adds the output signal of the inverting amplifier circuit to the noise signal and outputs the resultant signal; and a speaker unit outputting an audio signal and the cancel signal, comprises the steps of: extracting a signal in a predetermined frequency band from the noise signal using the filter circuit; inverting the extracted signal and amplifying it at amplification degree being greater than zero and smaller than one; and outputting a signal obtained by adding the inverted and amplified signal to the noise signal, wherein the noise can be canceled by outputting the signal output after the addition from the speaker unit.

Moreover, according to the present invention, in the noise-canceling method, the filter circuit may be a low-pass filter, a high-pass filter, a band-pass filter, or a notch filter.

According to the present invention, a noise-canceling system and a noise-canceling method capable of canceling noise over a wide frequency band naturally and exhibiting a natural noise-canceling effect without giving discomfort feeling to a user.

### BRIEF DESCRIPTION OF THE DRAWINGS

FIG. 1 is a section view schematically showing an embodiment of a noise-canceling headphone that is an example of a noise-canceling system according to the present invention;

FIG. 2 is a block diagram showing an example of a signal processing system of a noise-canceling unit provided to the noise-canceling system;

FIG. 3 is a graph showing an example of the phase characteristics of a high-pass filter circuit provided to the noise-canceling unit;

FIG. 4 is a graph showing an example of the phase characteristics of a phase inverting filter circuit provided to the noise-canceling unit;

FIG. 5 is a graph showing an example of the gain characteristics of the phase inverting filter circuit; and

FIG. 6 is a block diagram showing an example of another signal processing system of the noise-canceling unit provided to the noise-canceling system.

### DESCRIPTION OF THE PREFERRED EMBODIMENTS

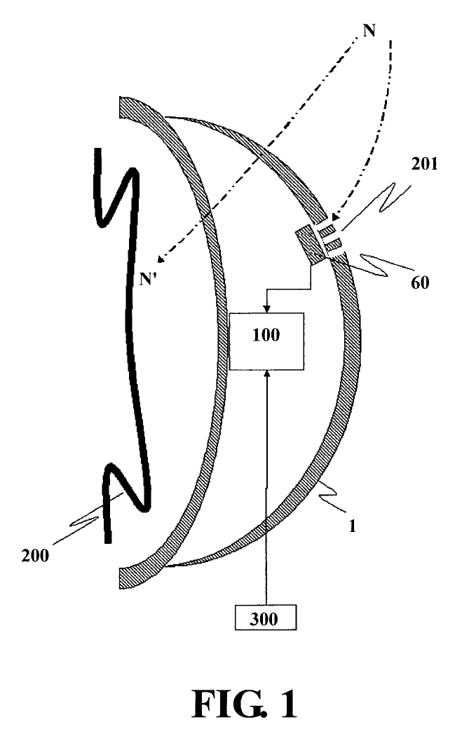

An example of an embodiment of a noise-canceling system according to the present invention will be described. Here, the present invention is applied to an example of a noise-canceling headphone that is an example of the noise-canceling system. FIG. 1 is a schematic diagram showing only a case of one side of the noise-canceling headphone composed of a pair of right and left parts. In FIG. 1, inside a headphone case 1, a noise-canceling unit 100 (hereinafter, referred to as “NC unit 100”), that is a core part of the noise-canceling system, and a microphone unit 60 that picks up ambient noise N of the noise-canceling headphone and converts the noise N to an electric signal to output it, are incorporated toward outside of the headphone case 1. A part of an outer wall of the headphone case 1 is provided with a through-hole 201 that helps the microphone unit 60 to pick up the noise N. The NC unit 100 is provided with a speaker unit that outputs a music signal input by being connected to a sound source 300 such as a portable music player and a cancel sound canceling noise N′ heard by ears 200 through the headphone case 1 towards the ears 200. The headphone case 1 also contains a battery, not shown, which is a drive power source of the NC unit 100.

The noise-canceling headphone that is one example of the noise-canceling system according to the present invention is realized by connecting the pair of left and right headphone cases 1 with, for example, a head band. Both of the configurations of the right and left headphone cases 1 may have a configuration as shown in FIG. 1, where a cable is connected to each of the cases 1 for inputting a music signal from a sound source 300, or when the type of a headphone is one where the right and left headphone cases 1 are connected by a headband, a wire that transmits the music signal from one of the case 1 to the other case 1 may be embedded in the headband. Moreover, the battery for driving may be configured to be mounted in only one of the headphone cases 1.

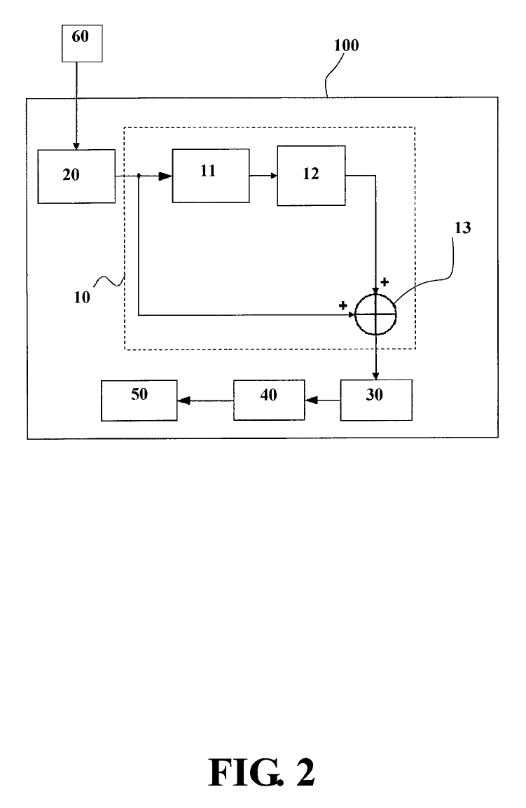

Next, details of the NC unit 100 will be described using a block diagram in FIG. 2. In FIG. 2, the NC unit 100 has: a microphone amplifier 20 that adjusts a noise signal picked up and converted into an electric signal by a microphone unit 60 to a predetermined level and outputs the resultant signal; a phase inverting filter circuit 10 composed of a filter circuit 11 that extracts and outputs a signal in a predetermined frequency band included in the noise signal output from the microphone amplifier 20, an inverting amplifier circuit 12 that inverts the output signal of the filter circuit 11 and amplifies the signal M times and outputs the resultant signal, and an adding circuit 13 that adds the noise signal output from the microphone amplifier 20 and the output signal of the inverting amplifier circuit 12 and outputs the resultant cancel signal; an amplifier 30 that amplifies the cancel signal output from the phase inverting filter circuit 10; a headphone amplifier 40 for driving a speaker unit 50 by the output signal of the amplifier 30; and the speaker unit 50 that is driven by the headphone amplifier 40. Into the headphone amplifier 40, a cancel signal that is the output signal of the amplifier 30 and a music signal from the sound source 300 are input. The music signal may be added to the cancel signal with another adding circuit by providing it between the amplifier 30 and the headphone amplifier 40. From the speaker unit 50, the music and the cancel signal are output towards the ears 200 of a user. Noise heard by the ears 200 through the headphone case 1 is canceled by the cancel sound, and the user can listen to only the music.

The noise-canceling system according to the present invention is characterized by the phase-inverting filter circuit 10. Moreover, the noise-canceling method according to the present invention is characterized in the flow of operations of the phase-inverting filter circuit 10. Accordingly, details of the phase-inverting filter circuit 10 will be described as an embodiment of the present invention. The phase-inverting filter circuit 10 exhibits the same function as that of a filter circuit used for a conventional noise-canceling system, and also has a function of extracting a specific frequency component for generating a cancel signal from a noise signal picked up by the microphone unit 60. Since the phase-inverting filter circuit 10 inverts the output signal of the conventional filter circuit by the inverting amplifier circuit 12, when the phase-inverting filter circuit 10 is used as a low-pass filter, a high-pass filter is used as the filter circuit 11. Similarly, when the phase-inverting filter circuit 10 is used as a high-pass filter, a low-pass filter is used as the filter circuit 11, when the circuit 10 is used as a band-pass filter, a notch filter is used as the filter circuit 11, and when the circuit 10 is used as a notch filter, a band-pass filter is used as the filter circuit 11.

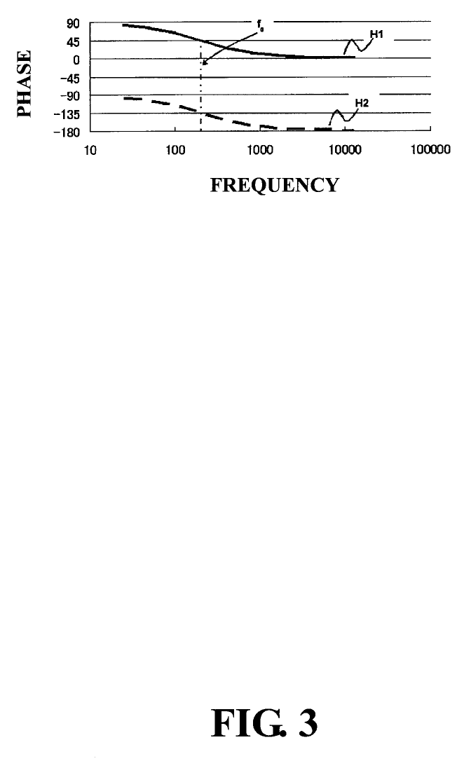

Here, when the filter circuit 11 is a high-pass filter, that is, an example where the phase-inverting filter circuit 10 is used as a low-pass filter to output a cancel signal, will be described. First, phase characteristics of the high-pass filter will be described using a drawing. FIG. 3 is a graph showing an example of the phase characteristics of the high-pass filter. In FIG. 3, the transversal axis represents the frequency (Hz) of the input signal in a logarithmic scale, and the longitudinal axis represents phase shift (°) between the input signal and the output signal in a normal scale. In addition, a cut-off frequency f₀ is set to 200 Hz.

If phase shift at the cut-off frequency f₀ is defined as θ_{f0}, because θ_{f0} is expressed as “tan⁻¹(1/(2πf₀CR)), 2πf₀=1/CR”, the phase shift θ_{f0} becomes tan⁻¹(1), and thereby at the cut-off frequency f₀, phase advances by 45°. That is, when the frequency of the input signal of the filter circuit 11 is low, the phase of the output signal advances by 90° from that of the input signal as near as possible, and thereby phase advance at the cut-off frequency f₀ will be 45°. Moreover as the frequency becomes higher the phase advance becomes slower, at frequency that is sufficiently higher than the cut-off frequency f₀, the shift between phases of the input and the output becomes approximately to 0°. Here, C and R derived above are resistance (R) of a resistor and capacitance (C) of a capacitor that are used for the filter circuit 11, respectively.

The output signal of the filter circuit 11 is inverted (phase is shifted by 180°) and amplified M times by the inverting amplifier circuit 12 of the subsequent stage, and the resultant signal is output. Accordingly, as for the phase characteristics, phase shift characteristics of the output signal (the input signal of the inverting amplifier circuit 12) of the filter circuit 11 and that of the output signal of the inverting amplifier circuit 12 will be shifted by 180° from the phase characteristics of the filter circuit 11, like Graph H2 in FIG. 3.

The cut-off frequency f₀ of the filter circuit 11 is also the cut-off frequency f₀ of the phase inverting filter circuit 10. Thereby, because the phase θ_{f0r} at the cut-off frequency f₀ is expressed by the work of the inverting amplifier circuit 12 as “−tan⁻¹(1/(2πf₀CR)), 2πf₀=1/CR”, the phase shift θ_{f0r} becomes −tan⁻¹(1), and thus the phase will delay by 45°. That is, the phase shift of the phase inverting filter circuit 10 at the cut-off frequency f₀ will relatively delay by 45°. This is a case where the amplification degree M of the inverting amplifier circuit 12 is one.

When amplification degree M is equal to or greater than zero and smaller than one, the formula is expressed as “−tan⁻¹(1/(M2πf₀CR)), 2πf₀=1/CR”. Thus, the phase shift θ_{f0r} of the phase inverting filter circuit 10 when amplification degree M is equal to or greater than zero and smaller than one, will be expressed by tan⁻¹(M), and thereby the phase shift changes within a range from 0° to −45° depending on the value of M. When the amplification degree M of the inverting amplifier circuit 12 is greater than one, at the frequency sufficiently higher than the cut-off frequency f₀, because the phase shift θᵣ of the phase inverting type filter circuit 10 has the same phase as the phase θ of the input signal, it is not suitable for obtaining the effect of the present invention. The phase characteristics θ_{rM} at that time is approximately expressed as “tan⁻¹(M/(M−1)2πfCR), M>1, f>>f₀”.

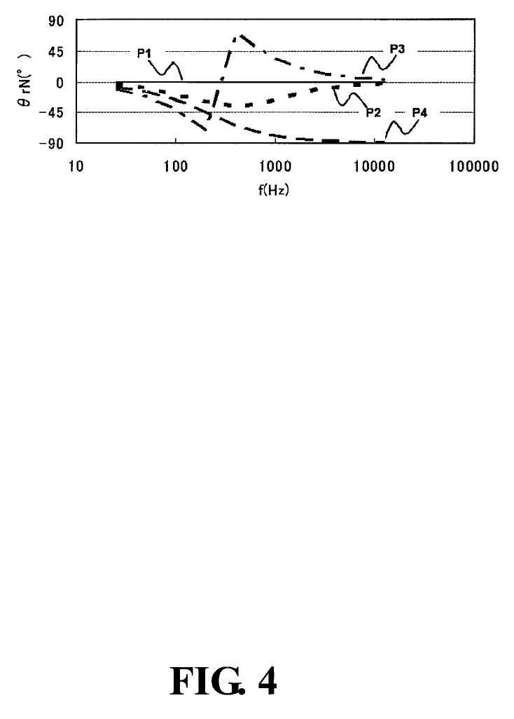

Consequently, phase characteristics θ_{rM} of a signal (cancel signal) that is obtained by adding the output signal of the inverting amplifier circuit 12 output from the adding circuit 13 and the output signal (noise signal) of the microphone amplifier 20 is expressed as “−tan⁻¹(M2πfCR/(1+(1−M) (2πfCR)²))”. An example of phase characteristics when amplification degree M is changed based on the formula, is shown in FIG. 4. In FIG. 4, the transversal axis represents the frequency (f) in a logarithmic scale, and the longitudinal axis represents phase shift θ_{rM} (°) between the output signal of the microphone amplifier 20 and the output signal of the phase inverting filter circuit 10 in a normal scale.

Graph P1 changing linearly at phase shift 0° represents a case where amplification degree M is zero. When amplification degree M is zero, because the output signal of the microphone amplifier 20 is the output signal of the phase inverting filter circuit 10, there is no phase shift between them. Graph P3 represented by a chain line shows a case where amplification degree M is 1.5. As already described, when amplification degree M of the inverting amplifier circuit 12 is greater than one, because at frequency greater than the cut-off frequency f₀ (200 Hz in the present embodiment) the phase of the output signal of the phase inverting filter circuit 10 approaches to that of the noise signal input from the microphone amplifier 20, its relative phase will advance. Accordingly, in Graph P3, at frequency greater than the cut-off frequency f₀, the phase shift turns into a state of advance.

Graph P4 represented by a long dotted line shows a case where amplification degree M is one. When M is one, because the phase characteristics of the filter circuit 11 is directly reflected, as frequency becomes higher the phase will delay. Because the output signal of the microphone amplifier 20 input into the adding circuit 13 and the output signal of the inverting amplifier circuit 12 has substantially the same phase at a low frequency, the phase shift is substantially 0°, however, the phase characteristics of the filter circuit in that as frequency becomes higher the phase delays, appears directly, thereby, in Graph P4, tendency that the phase shift will be substantially 0° at a low frequency, and as frequency becomes higher the phase shift will delay largely, is shown.

Graph P2 represented by a short dotted line shows a case where amplification degree M is 0.75. In the case, the output signal level of the inverting amplifier circuit 12 will be lower (0.75 times) than the original signal (the output signal of the microphone amplifier 20). Accordingly, in the adding circuit 13 an inverting signal being 0.75 times of the output signal of the microphone amplifier 20 will be added to the output signal. At frequency lower than the cut-off frequency f₀, because the phase shift amount between the output signal of the microphone amplifier 20 and that of the inverting amplifier circuit 12 is small, that is, the phases of them are substantially the same one, however, as frequency becomes higher the phase shift will be slowly in a state of “delay”. At frequency higher than the cut-off frequency f₀, because the phase shift will reduce slowly, thereby both phases will approach to the same phase, as frequency becomes higher the phase shift will be in a state of “advance”, and thereby phase characteristics like Graph P2 will be obtained. Because of this, such phase characteristics that as frequency becomes higher the phase will advance relatively, will be obtained.

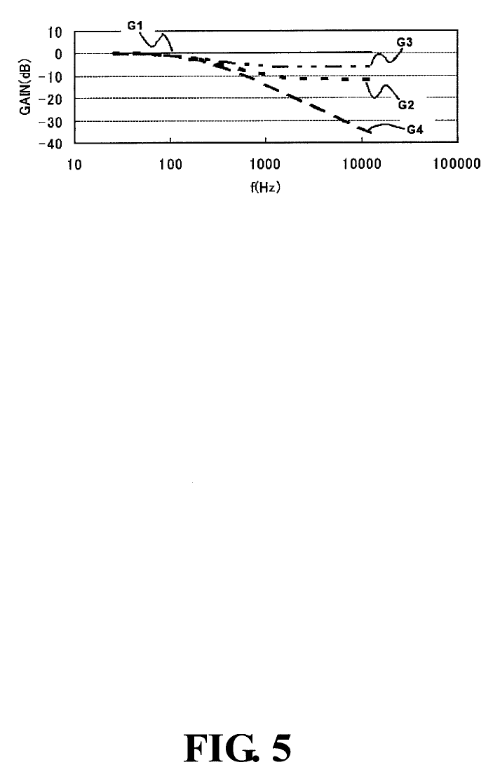

Next, gain characteristics of the phase inverting filter 10 will be described using FIG. 5. In FIG. 5, the longitudinal axis represents the gain (dB) of the phase inverting filter 10, and the transversal axis represents the frequency (Hz) of the input signal of the filter 10 in a logarithmic scale. When the amplification degree M of the inverting amplifier circuit 12 is zero, because the output signal of the filter circuit 11 will not be amplified at all, the gain will be 0 dB, as shown in Graph G1. When the amplification degree M is 1.5, the gain characteristics will be one as shown in Graph G3 represented by a chain double-dashed line. As the phase shift characteristics described above, because at frequency higher than the cut-off frequency f₀, the phase shift turns into a state of advance, the output signal level of the phase inverting filter circuit 10 will be suppressed by a signal larger than the signal input from the microphone amplifier 20 (because of the amplification degree M is 1.5). Accordingly, such gain characteristics that as frequency becomes higher the gain will be attenuated, will be shown.

Graph G4 represented by a long dotted line shows gain characteristics when amplification degree M is one. Because, the phase shift characteristics when amplification degree M is one is reflected by the phase characteristics of the filter circuit 11 directly, as frequency becomes higher the phase will delay. Because this is the same as the phase characteristics of the output signal of the microphone amplifier 20, the output signal of the adding circuit 13 will have the same gain characteristics of the output signal of the inverting amplifier circuit 12, and thereby gain characteristics that as frequency becomes higher the gain will be attenuated, will be obtained.

Graph G2 represented by a short dotted line, gain characteristics when amplification degree M is 0.75 is shown. As already described, in the phase shift characteristics at that time, the phase delays relatively at a low frequency, and as frequency becomes higher the phase shift reduces (the phase advances relatively), then both of the output signals will approach to the same phase. Thus, in the gain characteristics, as frequency becomes higher, the attenuation of the gain will be slower by the output signal of the inverting amplifier circuit 12, and thereby gain characteristics as shown in FIG. 5 can be obtained.

In the above-mentioned example, when amplification degree M is 0.75, phase shift characteristics that the phase delays relatively at a low frequency, and as frequency becomes higher the phase will advance relatively, can be obtained. The optimum value of the amplification degree M having a value that is equal to or greater than zero and smaller than one, depends on the characteristics of the microphone unit 60 and that of the speaker unit 50.

Next, an embodiment of a noise-canceling method according to the present invention will be described. In the NC unit 100 shown in FIG. 2, first, a noise signal converted into an electric signal by the microphone unit 60 is amplified to a predetermined level in the microphone amplifier 20. Next, in the filter circuit 11, at a predetermined cut-off frequency, a signal in a predetermined frequency band included in the noise signal is extracted. Next, in the inverting amplifier circuit 12, the extracted noise signal is inverted, and amplified at amplification degree M, and the resultant signal is output, as mentioned-above. Next, in the adding circuit 13, the noise signal output by the microphone amplifier 20 and the output signal of the inverting amplifier circuit 12 are added and output. Because the output signal of the adding circuit 13 is a cancel signal, the signal is amplified by the amplifier 30 and output from the speaker unit 50 through the headphone amplifier 40, and ambient noise is canceled by the output signal.

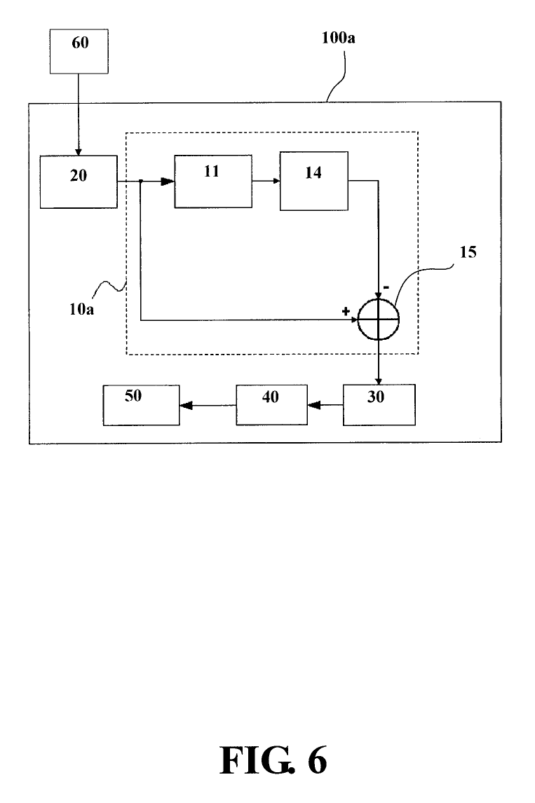

Next, another exemplary configuration of a headphone unit provided to a noise-canceling system according to the present invention, will be described using FIG. 6. In FIG. 6, an NC unit 100a is provided with a phase inverting filter circuit 10a having a configuration different from that of the phase inverting filter circuit 10 provided to the already described NC unit 100. Thus, the phase inverting filter circuit 10a will be described. The phase inverting filter circuit 10a is composed of the filter circuit 11 extracting and outputting a signal in a predetermined frequency band included in the noise signal output from the microphone amplifier 20, an amplifier circuit 14 amplifying the output signal of the filter circuit 11 by N times and outputting the resultant signal, and a subtracting circuit 15 subtracting the output signal of the amplifier circuit 14 from the noise signal output from the microphone amplifier 20 and outputting the resultant cancel signal.

In the embodiment of the already described noise-canceling system, the phase inverting filter circuit 10, by inverting and amplifying the output signal of the filter circuit 11 and adding the resultant signal to the original signal (the output signal of the microphone amplifier 20), obtained the cancel signal. On the contrary, the phase inverting filter circuit 10a of the embodiment shown in FIG. 6, by amplifying the output signal of the filter circuit 11 without inverting it, and subtracting the resultant signal from the original signal (the output signal of the microphone amplifier 20), obtains the cancel signal. The phase characteristics and the gain characteristics of the phase inverting filter circuit 10a are the same as those of the phase inverting filter circuit 10 of the above-mentioned embodiment. That is, by including the phase inverting filter circuit 10a, it is also possible to obtain a noise-canceling system according to the present invention.

The situation of an embodiment of a noise-canceling method is the same as that of the noise-canceling system, and in the subtracting circuit 15, because an output signal obtained by subtracting the output signal of the amplifier circuit 14 that is the output signal of the filter circuit 11 amplified at predetermined amplification degree M without being inverted, from the output signal of the microphone amplifier 20, becomes a cancel signal, by outputting it from the speaker unit 50 through the amplifier 30 and the headphone amplifier 40, it will be possible to cancel ambient noise.

As described-above, by including the phase inverting filter 10 or the phase inverting filter 10a, it will be possible to generate a cancel signal having such phase characteristics that at a low frequency the phase delays and at a high frequency the phase advances. Whether what filter characteristics is given to the phase inverting filter 10 or 10a, depends on the selection of the filter circuit 11. That is, if the circuit 11 is a low-pass filter, the phase inverting filter 10 or 10a will act as a high-pass filter. Moreover, if the filter 10 or 10a acts as a band-pass filter, a notch filter should be selected as the circuit 11, and if the filter 10 or 10a acts as a notch filter, a band-pass filter should be selected as the circuit 11.

As mentioned above, the noise-canceling system according to the present invention can be used for a noise-canceling headphone, and further it can also be used for a noise-canceling speaker etc.

1. A noise-canceling system comprising:
a microphone that picks up ambient noise and outputs a noise signal;
a cancel signal generator that receives the noise signal, and generates and outputs a cancel signal for reducing the ambient noise; and
a speaker that receives and outputs an audio signal and the cancel signal, wherein the cancel signal generator comprises:
a filter circuit that outputs a signal included in the noise signal in a predetermined frequency band;
an inverting amplifier circuit that inverts and amplifies the signal output by the filter circuit and outputs the inverted and amplified signal, wherein the signal is amplified by an amplification degree that is greater than zero and less than one; and
an adding circuit that outputs the cancel signal by adding the inverted and amplified signal output by the inverting amplifier circuit to the noise signal.

2. A noise-canceling system comprising:
a microphone that picks up ambient noise and outputs a noise signal;
a cancel signal generator that receives the noise signal, and generates and outputs a cancel signal for reducing the ambient noise; and
a speaker that receives and outputs an audio signal and the cancel signal, wherein the cancel signal generator comprises:
a filter circuit that outputs a signal included in the noise signal in a predetermined frequency band;
an amplifier circuit that amplifies the signal output by the filter circuit and outputs the amplified signal, wherein the signal is amplified by an amplification degree that is greater than zero and less than one; and
a subtracting circuit that outputs the cancel signal obtained by subtracting the amplified signal output by the amplifier circuit from the noise signal.

3. The noise-canceling system according to claim 1, wherein the filter circuit comprises a low-pass filter.

4. The noise-canceling system according to claim 1, wherein the filter circuit comprises a high-pass filter.

5. The noise-canceling system according to claim 1, wherein the filter circuit comprises a band-pass filter.

6. The noise-canceling system according to claim 1, wherein the filter circuit comprises a notch filter.

7. The noise canceling system according to claim 1, wherein the cancel signal is for canceling or substantially eliminating the ambient noise.

8. The noise-canceling system according to claim 2, wherein the filter circuit comprises a low-pass filter.

9. The noise-canceling system according to claim 2, wherein the filter circuit comprises a high-pass filter.

10. The noise-canceling system according to claim 2, wherein the filter circuit comprises a band-pass filter.

11. The noise-canceling system according to claim 2, wherein the filter circuit comprises a notch filter.

12. The noise canceling system according to claim 2, wherein the cancel signal is for canceling or substantially eliminating the ambient noise.
